(19) United States
(12) Patent Application Publication
(10) Pub. No.: US 2005/0201045 A1
(43) Pub. Date: Sep. 15, 2005

(54) Electronic apparatus and magnetic lock device thereof

(75) Inventors: Chien-Sheng Lo, Taipei City (TW); Wen Hung Wang, Taipei County (TW); Hung Chung Ku, Taipei City (TW); Yu Lin Fang, Taipei City (TW); Hung-Cheng Lee, Jhonghe City (TW); Ming Kai Hsiao, Taipei City (TW); Pin An Hsieh, Banciao City (TW)

Correspondence Address: BIRCH STEWART KOLASCH & BIRCH, PO BOX 747, FALLS CHURCH, VA, 22040-0747, US

(73) Assignee: ASUSTek COMPUTER INC.

(21) Appl. No.: 11/079,177

(22) Filed: Mar. 15, 2005

(30) Foreign Application Priority Data
Mar. 15, 2004 (TW) 093106894

(51) Int. Cl. G06F 1/16

(52) U.S. Cl. 361/679; 361/683

(57) ABSTRACT

A magnetic lock device is installed on a first body and a second body. The first body is connected pivotally to the second body. The magnetic lock device comprises at least one first element, at least one second element and at least one control module. In this case, the first element is located on the first body. The second element is located on the second body. When the first body and the second body are closed, the second element is in a first position and the first element faces to the second element for providing a magnetic attraction between the first body and the second body. The control module is located on the second body and connects to the second element. When a force in a first direction moves the control module, the control module drives the second element to leave the first position.

### BACKGROUND OF THE INVENTION

1. Field of Invention

The invention relates to an electronic apparatus and lock device thereof and, in particular, to an electronic apparatus and magnetic lock device thereof.

2. Related Art

With coming the electronic-times, the dependence and need of electronic products for people are increasing. In addition, the technology changes with each passing day, so consumers determine whether a product is worthy to be bought not only with considering the product's price but also considering the features and friendly use of the product. Therefore, the manufacturers of the electronic products always make the effort to think about how to fit the requirements of consumers.

For understanding the present invention easily, herein the notebook is taken as an example. With reference to FIG. 1, a conventional notebook comprises a host 1 and a monitor 2. A back side 21 of the monitor 2 is connected pivotally to a back side 11 of the host 1. The screen 22 of the monitor 2 faces to the host 1 and covers the upper surface 12 of the host 1. The host 1 further comprises a lock element 13.

In the conventional notebook, a lock deice 9 is disposed on the front side of the monitor 2. The lock device 9 comprises a hook 91 and a press-key 92. When the notebook is in a closed state, the hook 91 is protruding from the screen 22 and can be fasten to the lock element 13. For opening the notebook, the press-key 92 is pushed to separate the hook 91 and the lock element 13.

Because the lock device 9 is protruding from the screen in the conventional notebook, it isn't a good design for notebooks.

Therefore, according to the mentioned above, it is a subjective to provide a lock device, which is much easily used for users to open the notebook and doesn't destroy the design of the notebook.

### SUMMARY OF THE INVENTION

In view of the foregoing, the invention is to provide an electronic apparatus, which is much easily for user to open the notebook and doesn't destroy the design of the notebook, and magnetic lock device thereof.

To achieve the above, a magnetic lock device is installed on a first body and a second body. The first body is connected pivotally to the second body. The magnetic lock device comprises at least one first element, at least one second element and at least one control module. In this case, the first element is located on the first body. The second element is located on the second body. When the first body and the second body are closed, the second element is in a first position and the first element faces to the second element for providing a magnetic attraction between the first body and the second body. The control module is located on the second body and connects to the second element. When a force in a first direction moves the control module, the control module drives the second element to leave the first position.

To achieve the above, an electronic apparatus has a first body and a second body connected pivotally to the first body. The electronic apparatus comprises at least one first element, at least one second element and at least one control module. The first element is located on the first body. The second element is located on the second body. When the first body and the second body are closed, the second element is in a first position and the first element faces to the second element for providing a magnetic attraction between the first body and the second body. The control module is located on the second body and connects to the second element. When a force in a first direction moves the control module, the control module drives the second element to leave the first position.

As mentioned above, the electronic apparatus and the magnetic lock device thereof of the invention utilize the relative positions changing between the first element and the second element to change the magnetic attraction between them. Thus, users may open the notebook easily when the magnetic attraction decreases. Comparing to the prior art, the magnetic lock device of the invention may not destroy the design of the notebook and is much easily for user to open the notebook.

### BRIEF DESCRIPTION OF THE DRAWINGS

The invention will become more fully understood from the detailed description given herein below illustration only, and thus is not limitative of the present invention, and wherein:

FIG. 1 is a schematic view showing the conventional notebook;

FIG. 2 is a schematic view showing the magnetic lock device according to a first embodiment of the invention;

FIG. 3 is a sectional enlarged view showing the magnetic lock device according to the first embodiment of the invention;

FIG. 4 is a schematic view showing the motion of the magnetic lock device according to the first embodiment of the invention;

FIG. 5 is an exploded view showing the motion of the magnetic lock device according to a third embodiment of the invention; and

FIGS. 6A to 6C are schematic views showing the motions of the magnetic lock device according to the third embodiment of the invention.

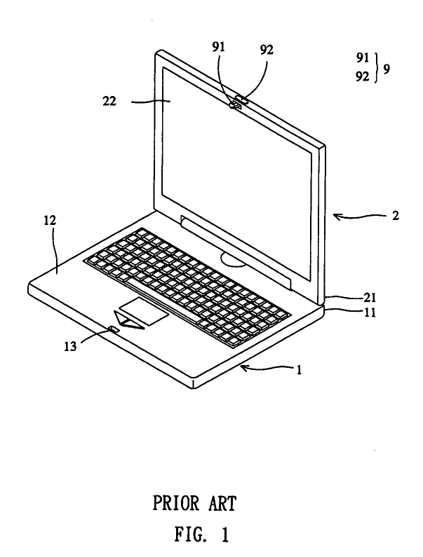

### DETAILED DESCRIPTION OF THE INVENTION

The present invention will be apparent from the following detailed description, which proceeds with reference to the accompanying drawings, wherein the same references relate to the same elements.

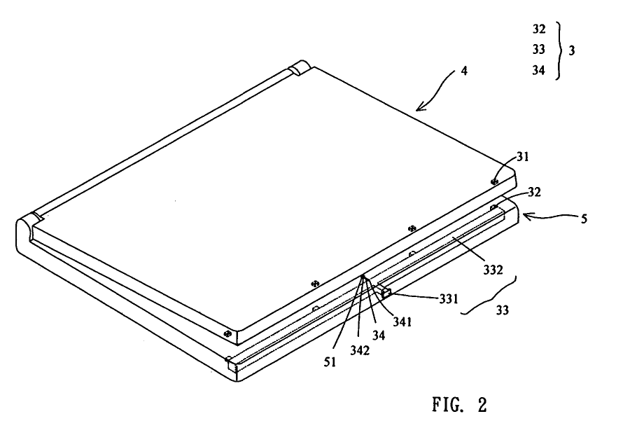

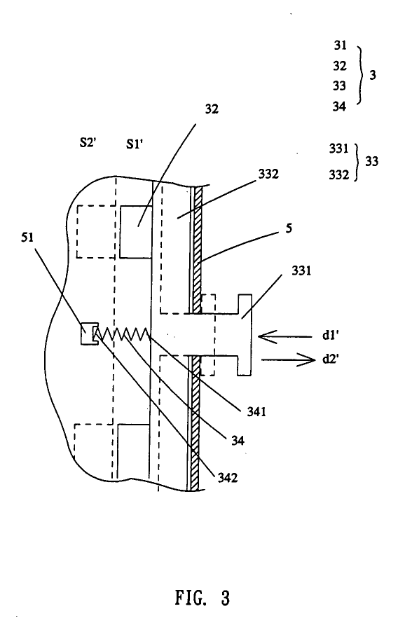

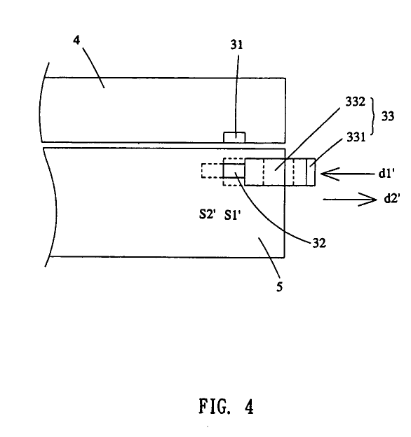

With reference to FIG. 2, FIG. 3 and FIG. 4, the magnetic lock device 3 according to a first embodiment of the invention is installed on a first body 4 and a second body 5. The first body 4 is connected pivotally to the second body 5. The magnetic lock device 3 comprises at least one first element 31, at least one second element 32 and at least one control module 33. The first body 4 may be a monitor and also may be a host.

The first element 31 is located on the first body 4. The second element 32 is located on the second body 5 and is in a first position S1′ (as shown in FIG. 3). When the first body 4 and the second body 5 are closed, the second element 32 faces to the first element 31 for providing a magnetic attraction between the first body 4 and the second body 5.

When the first element 31 is a magnet, the second element 32 comprises metal. And, when the first element 31 comprises metal, the second element 32 is a magnet.

The control module 33 is located on the second body 5 and connects to a side of the second element 32. And, the second element 32 and the control module 33 move together. The second element 32 may be fixed on the control module 33 in a heat-fusion way or by an adhesive. Also, the second element 32 may be at least one part of the control module 33.

The control module 33 further comprises a touch element 331 and an extending element 332 connecting to the touch element 331. The second element 32 is disposed on the extending element 332, and the second element 32 and the touch element 331 move together.

When the control module 33 is moved by a force in a first direction d1′, the control module 33 drives the second element 32 to leave the first position S1′. And, when the control module 33 drives the second element 32 to a second position S2′, the first element 31 doesn't face to the second element 32. Further, the second element 32 is in the second position S2′, the magnetic attraction between the first element 31 and the second element 32 is less than the magnetic attraction between the first element 31 and the second element 32 when the second element 32 is in the first position S1′. Thus, users can easily open the first body 4 away from the second body 5.

The magnetic lock device 3 further comprises a first elastic element 34, and the second body 5 further comprises a first fixing portion 51. A first end 341 of the first elastic element 34 connects to the control module 33, and a second end 342 of the first elastic element 34 connects to the first fixing portion 51. When the control module 33 is moved by the force in the first direction d1′, the first elastic element 34 has a backward elasticity in a second direction d2′ due to the second end 342 of the first elastic element 34 is restricted by the first fixing portion 51. The second direction d2′ is opposite to the first direction d1′. The backward elasticity of the first elastic element 34 makes the second element 32 returnable to the first position S1′.

The electronic apparatus according to the second embodiment of the invention has a first body and a second body connected pivotally to the first body. The electronic apparatus comprises at least one first element, at least one second element and at least one control module. The first element is located on the first body. The second element is located on the second body. When the first body and the second body are closed, the second element is in a first position and the first element faces to the second element for providing a magnetic attraction between the first body and the second body. The control module is located on the second body and connects to the second element. When the control module is moved by a force in a first direction, the control module drives the second element to leave the first position.

Due to the structures, the depositions and the actions of the first element, the second element, and the control module in this embodiment are the same as those of the previously mentioned magnetic device 3, the detailed descriptions are omitted for concise purpose. To be noted, when the control module is moved by force in the first direction, the control module drives the second element to leave the first position and the first element doesn't face to the second element. Also, when the second element is in the second position, the magnetic attraction between the first element and the second element become less. Thus, users can easily open the first body away from the second body. Comparing to the prior art, the magnetic lock device of the embodiment may not destroy the design of the notebook and is much easily for user to open the notebook.

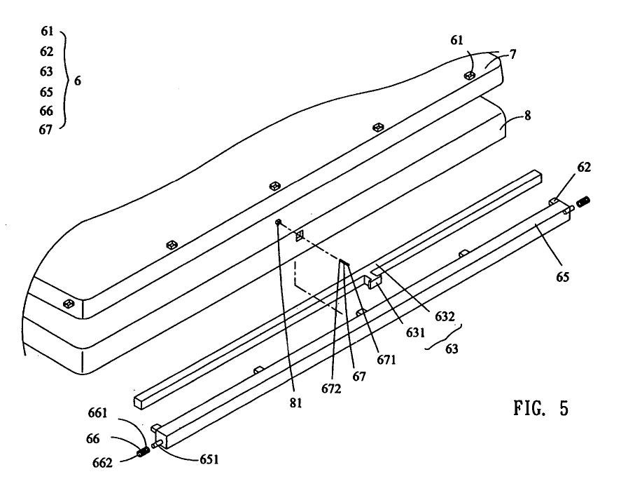

With reference to FIG. 5, the magnetic lock device 6 according to a third embodiment of the invention is separately located on a first body 7 and a second body 8. The first body 7 is connected pivotally to the second body 8. The magnetic lock device 6 comprises at least one first element 61, at least one second element 62 and at least one control module 63. The first body 7 may be a monitor and also may be a host.

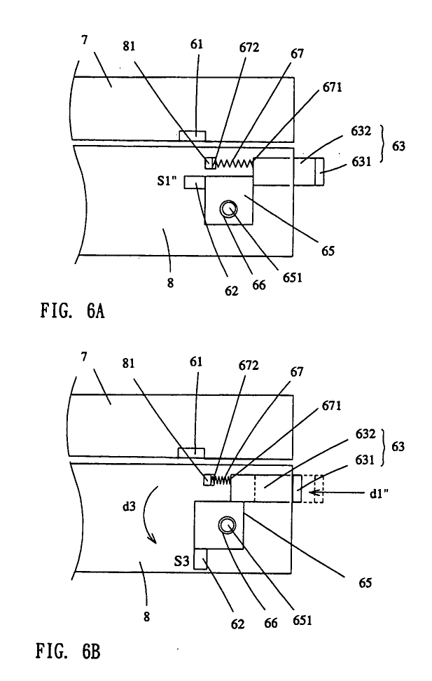

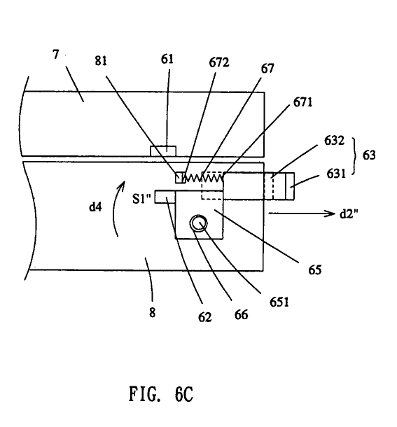

The first element 61 is located on the first body 7. The second element 62 is located on the second body 8 and is in a first position S1″ (as shown in FIG. 6A). When the first body 7 and the second body 8 are closed, the second element 62 faces to the first element 61 for providing a magnetic attraction between the first body 7 and the second body 8.

When the first element 61 is a magnet, the second element 62 comprises metal. And, when the first element 61 comprises metal, the second element 62 is a magnet.

The control module 63 further comprises a touch element 631, an extending element 632 and a rotating element 65. The extending element 632 connects to the touch element 631.

The rotating element 65 and the extending element 632 connect to each other, and the second element 62 is disposed on the rotating element 65. The second element 62 may be fixed on the rotating element 65 in a heat-fusion way or by an adhesive. Also, the second element 62 may be at least one part of the rotating element 65. The rotating element 65 connected by a pivot 651 to the second body 8, and the second element 62 is disposed on the rotating element 65. A second elastic element 66 connects to the pivot 651, and a third end 661 of the second elastic element 66 connects to the rotating element 65. And, a fourth end 662 of the second elastic element 66 connects to a second fixing portion (not shown in figure) of the second body 8.

With reference to FIG. 6A, FIG. 6B and FIG. 6C, when the control module 63 is moved by a force in a first direction d1″, the control module 63 pushes the rotating element to rotate in a third direction d3, so as to the second element 62 is moved to the third position S3. And, when the second element 62 is in the third position S3, the first element 61 doesn't face to the second element 62, and the magnetic attraction between the first element 61 and the second element 62 is less than the magnetic attraction between the first element 61 and the second element 62 when the second element 62 is in the first position S1′. Because of the decrease of the magnetic attraction, the users can easily open the first body 7 away from the second body 8. The rotating element 65 rotates at least one portion of the second elastic element 66, the second elastic element 66 has a backward elasticity in a fourth direction d4 due to the fourth end 662 of the second elastic element 66 is restricted by the second fixing portion. The third direction d3 is opposite to the fourth direction d4. The backward elasticity of the second elastic element 66 makes the second element 62 returnable to the first position S1″. The second elastic element may be a twisted spring.

The magnetic lock device 6 further comprises a third elastic element 67. A fifth end 671 of the third elastic element 67 connects to the control module 63, and a sixth end 672 of the third elastic element 67 connects to the a third fixing portion 81 of the second body 8. When the control module 63 is moved by the force in the first direction d1″, the control module 63 pushes the rotating element 65, and the rotating element 65 drives the second element 62 to leave the first position d1″. The third elastic element 67 has a backward elasticity in the second direction d2″ due to the third elastic element 67 is restricted by the third fixing element 81, and the backward elasticity of the third elastic element 67 makes the control module 63 movable in the second direction d2″.

The electronic apparatus according to the fourth embodiment of the invention has a first body and a second body connected pivotally to the first body. The electronic apparatus comprises at least one first element, at least one second element, at least one control module and a rotating element. The first element is located on the first body. The second element is located on the second body. When the first body and the second body are closed, the second element is in a first position and the first element faces to the second element for providing a magnetic attraction between the first body and the second body. The control module is located on the second body and connects to the second element. When the control module is moved by a force in a first direction, the control module pushes the rotating element, so as to the rotating element drives the second element to leave the first position.

Due to the structures, the depositions and the actions of the first element, the second element, the control module and the rotating element in this embodiment are the same as those of the previously mentioned magnetic device 6, the detailed descriptions are omitted for concise purpose. To be noted, when the control module is moved by force in the first direction, the control module drives the second element to leave the first position and the first element doesn't face to the second element. When the second element is in the second position, the magnetic attraction between the first element and the second element become less. Thus, users can easily open the first body away from the second body. Comparing to the prior art, the magnetic lock device of the embodiment may not destroy the design of the notebook and is much easily for user to open the notebook.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1-33. (canceled)

34. A magnetic lock device, which is installed on a first body and a second body, wherein the first body is connected pivotally to the second body, comprising:
at least one first element, which is located on the first body;
at least one second element, which is located on the second body, when the first body and the second body are closed, the second element is in a first position and the first element faces to the second element for providing a magnetic attraction between the first body and the second body; and
at least one control module, which is located on the second body and connects to the second element, wherein when the control module is moved by a force in a first direction, the control module drives the second element to leave the first position.

35. The magnetic lock device of claim 34, wherein the first element is a magnet and the second element comprises metal.

36. The magnetic lock device of claim 34, wherein the first element comprises metal and the second element is a magnet.

37. The magnetic lock device of claim 34, wherein the control module further comprises a touch element and an extending element connecting to the touch element, the second element is disposed on the extending element, and the second element and the touch element move together.

38. The magnetic lock device of claim 34, wherein when the control module drives the second element to a second position, the first element doesn't face to the second element, and the magnetic attraction between the first element and the second element is less than the magnetic attraction between the first element and the second element when the second element is in the first position.

39. The magnetic lock device of claim 34, further comprising a first elastic element, wherein the second body further comprises a first fixing portion, a first end of the first elastic element connects to the control module, a second end of the first elastic element connects to the first fixing portion, when the control module is moved by the force in the first direction, the first elastic element has a backward elasticity in a second direction due to the second end of the first elastic element is restricted by the first fixing portion, the second direction is opposite to the first direction, and the backward elasticity of the first elastic element makes the second element returnable to the first position.

40. The magnetic lock device of claim 34, wherein the control module further comprises a rotating element connected by a pivot to the second body, the second element is disposed on the rotating element, a second elastic element connects to the pivot, a third end of the second elastic element connects to the rotating element and a fourth end of the second elastic element connects to a second fixing portion of the second body, the second element moves between the first position and a third position, when the second element is in the third position, the first element doesn't face to the second element, the magnetic attraction between the first element and the second element is less than the magnetic attraction between the first element and the second element when the second element is in the first position.

41. The magnetic lock device of claim 40, wherein when the rotating element is rotated in a third direction and the second element is moved to the third position, the rotating element rotates at least one portion of the second elastic element, the second elastic element has a backward elasticity in a fourth direction due to the fourth end of the second elastic element is restricted by the second fixing element, the third direction is opposite to the fourth direction, the backward elasticity of the second elastic element makes the second element be returnable to the first position.

42. The magnetic lock device of claim 40, further comprising a third elastic element, a fifth end of the third elastic element connects to the control module, a sixth end of the third elastic element connects to the a third fixing portion of the second body, when the control module is moved by the force in the first direction, the control module pushes the rotating element, and the rotating element drives the second element to leave the first position, the third elastic element has a backward elasticity in the second direction due to the third elastic element is restricted by the third fixing element, and the backward elasticity of the third elastic element makes the control module be moved in the second direction.

43. The magnetic lock device of claim 34, wherein the first body is a monitor.

44. The magnetic lock device of claim 34, wherein the first body is a host.

45. The magnetic lock device of claim 40, wherein the second elastic element is a twisted spring.

46. An electronic apparatus, which has a first body and a second body connected pivotally to the first body, comprising:
at least one first element, which is located on the first body;
at least one second element, which is located on the second body, when the first body and the second body are closed, the second element is in a first position and the first element faces to the second element for providing a magnetic attraction between the first body and the second body; and
at least one control module, which is located on the second body and connects to the second element, wherein when the control module is moved by a force in a first direction, the control module drives the second element to leave the first position.

47. The electronic apparatus of claim 46, wherein the first element is a magnet and the second element comprises metal.

48. The electronic apparatus of claim 46, wherein the first element comprises metal and the second element is a magnet.

49. The electronic apparatus of claim 46, wherein the control module further comprises a touch element and an extending element connecting to the touch element, the second element is disposed on the extending element, and the second element and the touch element move together.

50. The electronic apparatus of claim 46, wherein when the control module drives the second element to a second position, the first element doesn't face to the second element, and the magnetic attraction between the first element and the second element is less than the magnetic attraction between the first element and the second element when the second element is in the first position.

51. The electronic apparatus of claim 46, further comprising a first elastic element, wherein the second body further comprises a first fixing portion, a first end of the first elastic element connects to the control module, a second end of the first elastic element connects to the first fixing portion, when the control module is moved by the force in the first direction, the first elastic element has a backward elasticity in a second direction due to the second end of the first elastic element is restricted by the first fixing element, the second direction is opposite to the first direction, and the backward elasticity of the first elastic element makes the second element be returnable to the first position.

52. The electronic apparatus of claim 46, wherein the control module further comprises a rotating element connected by a pivot to the second body, the second element is disposed on the rotating element, a second elastic element connects to the pivot, a third end of the second elastic element connects to the rotating element and a fourth end of the second elastic element connects to a second fixing portion of the second body, the second element moves between the first position and a third position, when the second element is in the third position, the first element doesn't face to the second element, the magnetic attraction between the first element and the second element is less than the magnetic attraction between the first element and the second element when the second element is in the first position.

53. The electronic apparatus of claim 52, wherein the second element is at least one part of the rotating element.

54. The electronic apparatus of claim 52, wherein when the rotating element is rotated in a third direction and the second element is moved to the third position, the rotating element rotates at least one portion of the second elastic element, the second elastic element has a backward elasticity in a fourth direction due to the fourth end of the second elastic element is restricted by the second fixing element, the third direction is opposite to the fourth direction, the backward elasticity of the second elastic element makes the second element be returnable to the first position.

55. The electronic apparatus of claim 52, further comprising a third elastic element, a fifth end of the third elastic element connects to the control module, a sixth end of the third elastic element connects to the a third fixing portion of the second body, when the control module is moved by the force in the first direction, the control module pushes the rotating element, and the rotating element drives the second element to leave the first position, the third elastic element has a backward elasticity in the second direction due to the third elastic element is restricted by the third fixing element, and the backward elasticity of the third elastic element makes the control module be moved in the second direction.

56. The electronic apparatus of claim 46, wherein the first body is a monitor.

57. The electronic apparatus of claim 46, wherein the first body is a host.

58. The electronic apparatus of claim 52, wherein the second elastic element is a twisted spring.
